(19) United States
(12) Patent Application Publication
(10) Pub. No.: US 2011/0036214 A1
(43) Pub. Date: Feb. 17, 2011

(54) TORQUE ADJUSTING DRIVE SYSTEMS AND PACKAGED TORQUE ADJUSTING DRIVE SYSTEMS

(75) Inventor: Russell A. Potterfield, Columbia, MO (US)

Correspondence Address: PERKINS COIE LLP;PATENT-SEA, P.O. BOX 1247, SEATTLE, WA, 98111-1247, US

(73) Assignee: Battenfeld Technologies, Inc., Columbia, MO (US)

(21) Appl. No.: 11/935,381

(22) Filed: Nov. 5, 2007

Related U.S. Application Data
(60) Provisional application No. 60/856,769, filed on Nov. 3, 2006.

(51) Int. Cl. B25B 23/142; B65D 85/00

(52) U.S. Cl. 81/467; 206/374

(57) ABSTRACT

Torque adjusting drive systems and packaged torque adjusting drive systems are disclosed herein. One aspect of the disclosure is directed to systems and torque adjusting drivers for specific firearm-related work tasks. In one embodiment, a torque adjusting drive system includes a torque adjusting driver. The driver includes a shaft assembly having a fastener coupling portion and a handle. The driver also includes a torque adjusting mechanism for setting a user-selected torque value and a torque value indicator mounted on the driver for displaying at least the user-selected torque value. In addition to the driver, the system also includes a plurality of fastener interfacing attachments configured to couple to the fastener coupling portion and for driving one or more target fasteners. The system further includes a torque guide having a plurality of representative indicia of the target fasteners, wherein the torque guide communicates recommended torque value settings for the target fasteners.

### CROSS-REFERENCE TO RELATED APPLICATION

This application claims priority to U.S. Provisional Patent Application No. 60/856,769, filed Nov. 3, 2006, entitled “FIREARM WRENCH ASSEMBLIES AND PACKAGED FIREARM WRENCH ASSEMBLIES,” and which is incorporated by reference in its entirety herein.

### TECHNICAL FIELD

The present disclosure is directed generally to torque adjusting drive systems and packaged torque adjusting drivers including torque guides and fastener interfacing attachments.

### BACKGROUND

Gunsmiths, craftsmen, builders, mechanics, hobbyists, etc. use a variety of tools in their respective trades or interests. Commonly, screwdrivers and other fastener drive tools are used to insert, tighten and loosen mechanical fasteners in various attachment substrates as needed during building or maintenance operations. During many of these operations, the fasteners and/or the substrate materials may be fragile and/or sensitive to over-tightening.

Conventional tool systems for affixing or removing fasteners include a standard screwdriver, a screwdriver with a detachable head and bits, or a torque wrench. Screwdriver bits are found in a variety of sizes and are designed to address the most common size and design needs for most general projects. Thus, screwdrivers and torque wrenches found in the prior art are not customized to a specific project or activity; to the contrary, the bit and other attachment mechanisms are provided to accommodate the most commonly needed sizes in order to be used in the majority of general projects.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the torque adjusting drive system elements as drawn, are not intended to convey any information regarding the actual shape of the particular elements, and have been solely selected for ease of recognition in the drawings.

FIG. 1 is an isometric view of a torque adjusting drive system in accordance with an embodiment of the disclosure.

FIGS. 2A-C are perspective views of a handle portion of a torque adjusting driver illustrating the steps for adjusting and setting a user-selected torque value in accordance with an embodiment of the disclosure.

FIG. 3 is an isometric view of the torque adjusting drive system of FIG. 1A illustrating a first torque guide attached to a torque adjusting driver in accordance with an embodiment of the disclosure.

FIG. 4 is an isometric view of a torque adjusting driver and torque guide in accordance with another embodiment of the disclosure.

FIG. 5A is a front view of a torque adjusting drive system retained in a package in accordance with an embodiment of the disclosure.

FIG. 5B is a front view of a torque adjusting drive system retained in a package in accordance with another embodiment of the disclosure.

FIG. 6 is a front view illustrating additional packaging material in accordance with an embodiment of the disclosure.

FIG. 7 is a flow chart representing a method for packaging a torque adjusting drive system in accordance with an embodiment of the disclosure.

### DETAILED DESCRIPTION

### A. Overview

The following disclosure describes several embodiments of torque adjusting drive systems and packaged torque adjusting drive systems. According to aspects of the disclosure, the torque adjusting drive system may be used in a variety of applications, for example, firearm accessories; automobiles, motor homes, tractors and/or recreational vehicles; motorcycles; medical devices; small-engine repair kits; testing and inspection equipment; electronic assemblies; outboard motors for boats; plumbing assemblies; and other home-improvement or hobby specific projects. One embodiment of the disclosure, for example, is directed to torque adjusting drive systems for firearm-related applications, however, one skilled in the art will recognize that the torque adjusting drive system disclosed and described herein may be used in a variety of applications, projects and tasks and still be within the scope of the invention.

According to one embodiment, a torque adjusting drive system includes a torque adjusting driver. The driver includes a shaft assembly having a fastener coupling portion and a handle. The driver also includes a torque adjusting mechanism for setting a user-selected torque value and a torque value indicator associated with the driver for displaying at least the user-selected torque value. In addition to the driver, the system also includes a plurality of fastener interfacing attachments, for example, bits or sockets, configured to couple to the fastener coupling portion and for driving one or more target fasteners. The system further includes a torque guide having a plurality of representative indicia of the target fasteners, wherein the torque guide communicates recommended torque value settings for the target fasteners.

In another embodiment, a torque adjusting drive system includes a torque adjusting driver having a shaft assembly for rotationally adjusting a torque value setting. The shaft assembly includes a handle portion and a fastener coupling portion. The handle portion includes an adjustment mechanism for selecting, locking and indicating the torque value setting. The system also includes a plurality of fastener interfacing attachments, wherein each fastener interfacing attachment is configured to engage the fastener coupling portion of the shaft assembly in a first fastener interfacing attachment end and engage one or more target fasteners on a second fastener interfacing attachment end. The system further includes a torque guide configured to provide one or more suggested torque values for the one or more target fasteners. The system also includes a package for retaining at least one of the torque adjusting driver, the fastener interfacing attachments and/or the torque guide.

Another aspect of the disclosure is directed to firearm torque adjusting drive systems. In one embodiment, a firearm torque adjusting drive system includes a torque adjusting driver having a shaft assembly for rotationally adjusting a torque setting, the shaft assembly including a handle portion and a fastener coupling portion. The handle portion includes an adjustment mechanism for selecting and locking the torque value setting. The system also includes a torque value indicator mounted on the driver for displaying at least a user-selected torque value. The system further includes one or more fastener interfacing attachments having a first end and a second end, the first end configured to releaseably engage the fastener coupling portion and the second end configured to releaseably engaging target fasteners. The system also includes a torque guide for providing torque value suggestions corresponding to a preselected applied torque for the target fasteners wherein the target fasteners are fasteners used in a firearm. The fasteners have one or more drive designs and the fastener interfacing attachments include one or more fastener interfacing attachment drive designs that correspond to the one or more fastener drive designs.

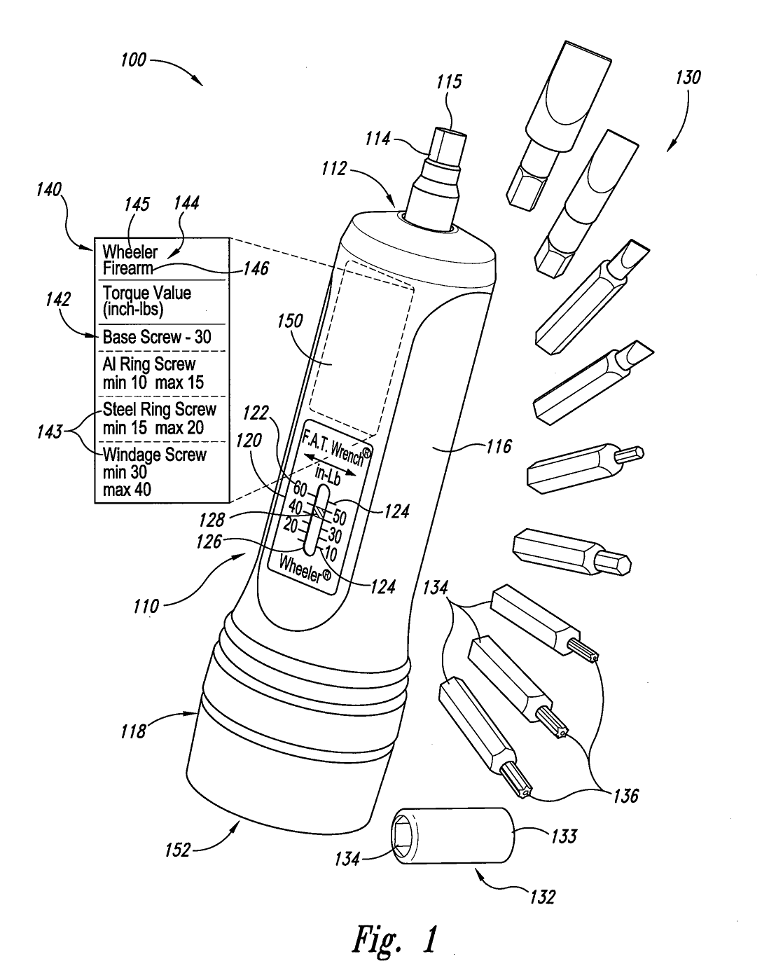

Specific details of several embodiments of the disclosure are described below with reference to torque adjusting drive systems. Several details describing well-known structures or processes often associated with tools and torque adjusting tools are not set forth in the following description for purposes of brevity and clarity. Also, several other embodiments of the disclosure can have different configurations, components, or procedures than those described in this section. A person of ordinary skill in the art, therefore, will accordingly understand that the disclosure may have other embodiments with additional elements, or the disclosure may have other embodiments without several of the elements shown and described below with reference to FIGS. 1A-5.

Where the context permits, singular or plural terms may also include the plural or singular term, respectively. Moreover, unless the word “or” is expressly limited to mean only a single item exclusive from other items in reference to a list of at least two items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same features and/or other types of features and components are not precluded.

### B. Embodiments of Torque Adjusting Drive Systems

FIG. 1 is an isometric view of a torque adjusting drive system 100 in accordance with one embodiment of the disclosure. The torque adjusting drive system 100 includes a torque adjusting driver 110 with a shaft assembly 112. The shaft assembly may include a fastener coupling portion 114 and a handle portion 116. The driver 110 may also include a torque adjusting mechanism 118 (described in more detail below) for setting a user-selected torque value. As discussed further below, the user-selected torque value may be selected according to predetermined torque setting values contained in a torque guide. The driver 110 may also include a torque value indicator 120 for displaying at least the user-selected torque value. The system 100 may also include a plurality of fastener interfacing attachments 130 configured to engage the fastener coupling portion 114 of the shaft assembly 112. The system 100 can further include a torque guide 140 configured to communicate information 142 pertaining to the suggested torque value settings for one or more target fasteners (not shown; e.g., screw, bolt, nut, etc.).

As shown in FIG. 1, the shaft assembly 112 may include the fastener coupling portion 114. In one embodiment, the fastener coupling portion 114 may include a universal drive design, such as a square drive 115. The shaft assembly 112 may also include the handle portion 116 designed to be grasped by a user's hand (not shown) when in use. The handle portion 116 may be configured to surround one or more internal springs (not shown) used for adjusting and accurately applying a user-selected torque value setting during a fastener tightening operation. The torque value may be selected from a range of appropriate settings, or may be selected from a pre-selected set of values recommended in the torque guide 140. In one embodiment, the torque value indicator 120 includes a scale 122 of torque value settings in a given measurement of pre-determined units. For example, the scale 122 may include a plurality of incremental lines 124 representing incremental gradations of torque values. Alternatively, the scale may include pre-selected set points corresponding to specific activities or components.

In one embodiment, the torque values include inches per pound (e.g., in-lb). As shown, the torque adjusting driver 110 may be adjusted between 10 and 60 in-lb. values. The total scale 122 may be divided into 10 in-lb increments with each increment indicated by an incremental line 124. In another embodiment, the torque value indicator 120 may include feet per pound (e.g., ft-lb). In yet another embodiment, the torque value indicator 120 may include metric measurements or other desired torque value setting measurements. As shown in FIG. 1, the torque value indicator 120 may have a window 126 through which a user can visualize an adjusting line 128 that moves with respect to the scale 122 when a user adjusts the torque value to a greater or lesser value.

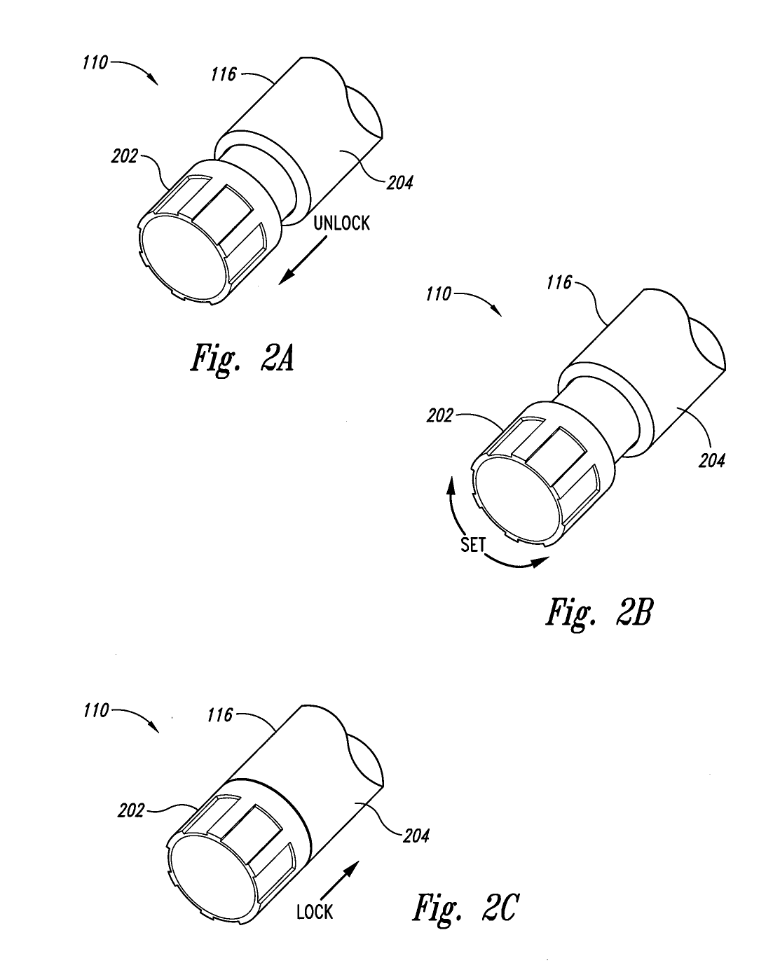

The handle portion 116 may also include the torque adjustment mechanism 118 for administering a change to the torque value setting of the driver 110. FIGS. 2A-C are perspective views of the handle portion 116 of a torque adjusting driver 110 illustrating the steps for adjusting and setting a user-selected torque value in accordance with an embodiment of the disclosure. The torque adjusting mechanism 118 can be used to alter a torque setting using the steps described herein. For example, FIG. 2A illustrates an unlocking step. To unlock the current torque value setting, a user would pull a bottom region 202 Of the handle portion 116 to disengage a locking mechanism (not shown) included in the shaft assembly 112. FIG. 2B illustrates a step for adjusting the torque value setting to a user-selected torque value setting. In one embodiment, the user may rotate the bottom region 202 clockwise or counter-clockwise to increase or decrease the torque value setting as desired. After adjusting the torque value setting and as illustrated in FIG. 2C, a user may lock-in the user-selected torque value setting by pushing the bottom region 202 toward an upper region 204 of the handle portion 116 to re-engage the locking mechanism of the shaft assembly 112. Accordingly, following the unlocking, adjusting and locking steps illustrated in FIGS. 2A-C, the user may used the torque adjusting driver 110 at the user-selected torque value setting without unintentional alteration of the torque value setting while using the driver 110.

Referring back to FIG. 1, the system 100 also includes the plurality of fastener interfacing attachments 130 for engaging target fasteners (not shown) during use of the driver 110. The system 100 may include any number of fastener interfacing attachments 130 having various sizes and drive designs. Drive designs may include a square drive, a torx drive, a Phillips drive, a hex drive, a slotted drive, a Pozidriv drive, a tri-wing drive, a torq-set drive, a spanner drive, a socket drive, a Leupold/Buehler windage drive, an Allen drive, a flat blade drive, and the like. As described above, the fastener coupling portion 114 of the shaft assembly 112 may have a universal drive design, such as the square drive 115. According to aspect of this embodiment, the system 100 can include an adaptor 132 (e.g., a square drive adaptor) configured to engage the square drive 115 on a first adaptor end 133 and engage one or more fastener interfacing attachments 130 on a second adaptor end 134. The first adaptor end 133 may include a square drive receptor for engaging the square drive 115. In one arrangement, the fastener interfacing attachments 130 may have a first fastener interfacing attachment end 134 having a hexagonal shape configured to be received in a corresponding hexagonal shaped second adaptor end 133. In another embodiment, the drive adaptor 132 may include magnets for releaseably engaging the square drive 115 and the first fastener interfacing attachment ends 134. Accordingly, each fastener interfacing attachment 130 can be releaseably engaged to the driver 110 via the adaptor 132. Each fastener interfacing attachment 130 can have a second fastener interfacing attachment end 136 having the drive design for engaging target fasteners (not shown) having corresponding drive designs.

In one embodiment, the fastener interfacing attachments 130 can be formed of metal, such as steel. In some embodiments, the steel may have a hardness degree between 56 and 58 on the Rockwell C scale. In one embodiment, the fastener interfacing attachments 130 can be coated for increasing strength. For example, the second fastener interfacing attachment end 136 or the entire fastener interfacing attachment 130 may be coated with layer of titanium-nickel coating, tin-coating, copper-coating, nickel-coating, zinc-coating, etc. In some embodiments, the surface coating may make at least the working tip resistant to wear. In another embodiment, the fastener interfacing attachments 130 may be hollow-ground. A hollow-ground fastener interfacing attachment 130 can have a radial profile that allows the second fastener interfacing attachment end 136 to be parallel along a bottom edge. The radial profile can allow a hollow-ground fastener interfacing attachment 130 to apply pressure over an entire fastener drive design slot (not shown), rather than just an upper surface of the slot. Because the hollow-ground fastener interfacing attachment 130 can engage the entire fastener slot, the applied torque can be equally distributed resulting in more accurate pressure distribution and less damage to the target fastener (not shown). Once the adaptor 132 and/or the fastener interfacing attachment 130 is engaged with the driver 110, torsion power may be translated from rotation of the shaft assembly, through the square drive adaptor and the fastener interfacing attachments 130, and finally through the engaged head of the target fastener.

As shown in FIG. 1, the torque adjusting drive system 100 is also provided with the torque guide 140. The torque guide 140 may be configured to communicate information 142 pertaining to a manufacturer's suggested torque value setting for one or more target fasteners for use in a selected activity. The torque guide 140 can have a plurality of indicia 143 and/or other reference information corresponding to the target fasteners (e.g., fastener name, location, color-coded reference, etc.).

As an example. FIG. 1 illustrates a single torque guide configured for use by a gunsmith to use with firearms and accessories. The torque guide, the torque driver and the fastener interfacing attachments, combine to provide a kit for use with an indicated activity, hobby, or device. For example, the torque adjusting drive system may be customized to be used in a variety of applications, for example, firearm accessories; automobiles, motor homes, tractors and/or recreational vehicles; motorcycles; medical devices; small-engine repair kits; testing and inspection equipment; electronic assemblies; outboard motors for boats; plumbing assemblies; and other home-improvement or hobby specific projects. As will be understood by one skilled in the art, the torque adjusting drive system for a defined activity, hobby or device will include an optimized set of fastener interfacing attachments and an optimized torque guide associated with the fastener interfacing attachments. In some embodiments, the torque adjusting drive system may include multiple torque drivers, for example, an in-lb driver and a ft-lb driver. In other embodiments, the torque adjusting drive system may include multiple torque drivers, each with a different drive designs, different shaft assembly housing configurations, or with different attached fastener interfacing attachments. In further embodiments, the torque adjusting drive system may include a variety of fastener interfacing attachment, for example, different size bits, different size sockets, a mixture of sockets and bits, and other fastener interfacing attachments as are known in the art.

As shown in FIG. 1, one exemplary embodiment of the disclosure is directed to torque adjusting drive systems for firearm-related applications, however, one skilled in the art will recognize that the torque adjusting drive system disclosed and described herein may be used in a variety of applications, projects and tasks and still fall within the scope of the disclosure.

In some embodiments, the guide 140 can also include other information (not shown) about the target fasteners, such as recommended or required drive design, a schematic diagram of the fastener locations, the fastener interfacing attachment to be used, fastener interfacing attachment serial number, references to additional manufacturing details, etc. In further embodiments, the torque guide 140 can also include general information 144 such as the manufacturer's or supplier's company name 145 and general target fastener information 146 (e.g., for firearms, archery equipment, bicycles, etc.). Other general information 144 may include company logo, contact information, reorder information, etc.

In one aspect of the disclosure (not shown), the torque guide 140 can have indicia 143 and/or information 142, 144, 145 in a variety of colors. For example, the indicia 143 and/or information 142, 144, 145 presented on the guide 140 can be printed, stamped, embossed, etc. on the guide 140 in colors other than black or white. Colors, such as red, orange, blue, green, etc. can be useful for product/logo recognition as well as can be attractive and eye-catching. Furthermore, the indicia 143 can be color-coded based on useful fastener characteristics such as desirable fastener interfacing attachment size, drive design, torque value setting, etc. The guide 140 may be laminated to protect printed information 142, 144, 145. In another embodiment, the guide 140 can be provided with a markable surface (not shown) having a writable surface. In this embodiment, a user can mark the guide 140 with user-specific notations, information, tool and task tips, etc.

As shown in FIG. 1, the torque guide 140 can be a removable and/or replaceable label that attaches to an exterior surface of the driver 110. For example, the label may be attached to the exterior surface 150 (shown in dotted lines) of the handle portion 114 so that a user can refer to the guide 140 when using the driver 110. Alternatively, the label can be attached to a bottom surface 152 of the driver 110. In another embodiment, not shown, the label can be attached to the torque value indicator 120. In this embodiment, the guide 140 can be provided with one or more holes (not shown) that aligns with the window 126 and/or the indicator lines 124. The indicia 143 representing the target fasteners may be aligned next to or otherwise refer to the section of the scale 122 corresponding to the suggested torque value setting for that target fastener.

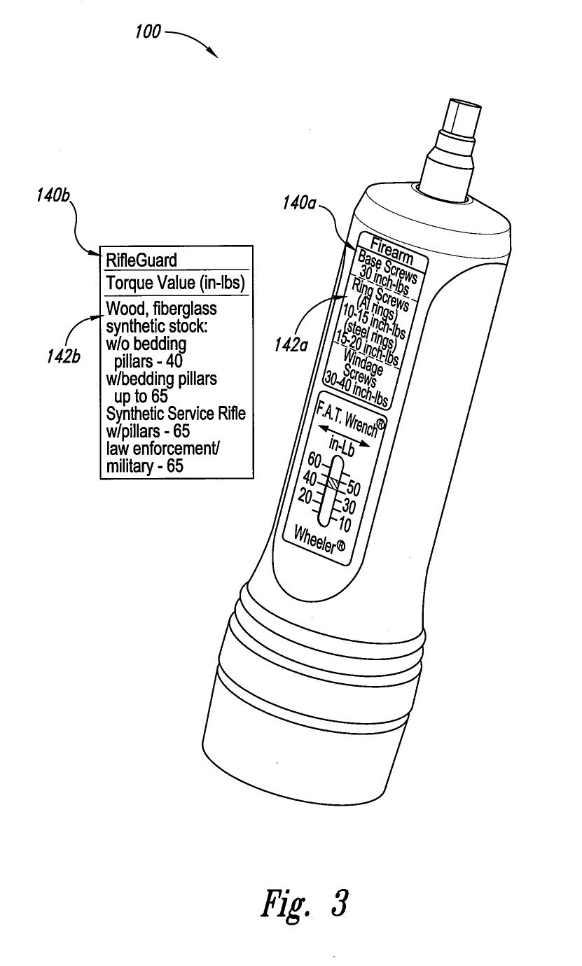

The torque guide 140 may be attached to the handle portion 116 with an adhesive, retaining clips or slots provided on the handle portion 116, corresponding magnetic components, corresponding hook and loop strips, etc. In another embodiment, the torque guide 140 can be made from a static adhering material configured to adhere to a surface of the handle portion 116. In some embodiments, the torque guide 140 may be removable and reusable. In one embodiment, illustrated in FIG. 3, the system 100 may include more than one torque guides 140a and 140b. The torque guides 140a and 140b may be used selectively and/or as needed when working on specific projects or tasks. For example, torque guide 140a includes information 142a directed to firearm fasteners and torque guide 140b includes information 142b directed to rifle guard fasteners. In other embodiments, the torque guide 140 may be replaceable. In still further embodiments, the torque guide 140 may be reconfigurable as needed to correspond accurately with the target fasteners and or user selected projects.

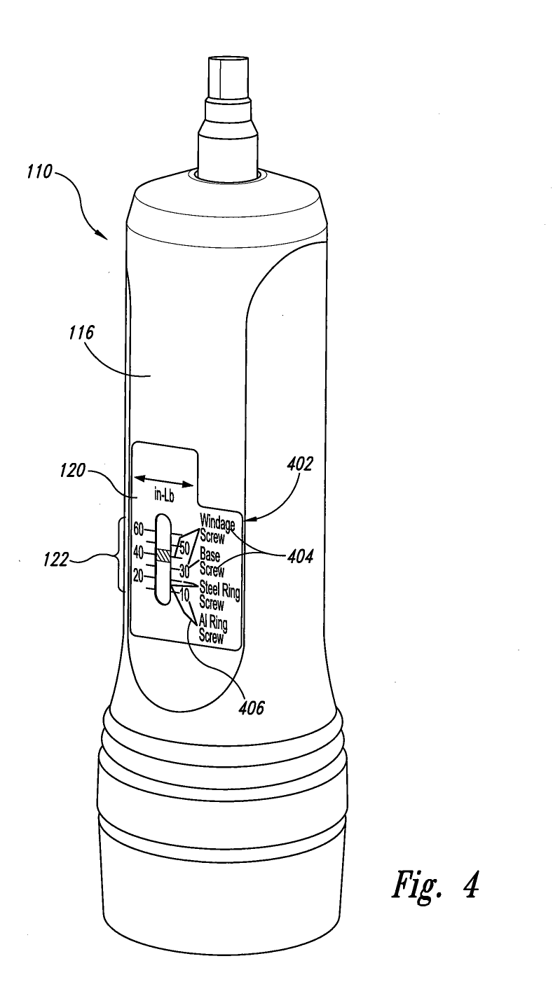

In yet another embodiment, illustrated in FIG. 4, the torque guide 402 may be permanently engraved on a portion of the driver 110 such as the handle portion 116. In this embodiment, the torque guide 402 may be associated with the torque value indicator 120 and or the scale 122. For example, the names 404, or other indicia, of the target fasteners may be engraved on the handle portion 116, and the torque guide 402 may include arrows 406 or other reference lines, pointing to the portion of the scale 122 that includes the suggested torque value setting corresponding to the particular target fastener name 404.

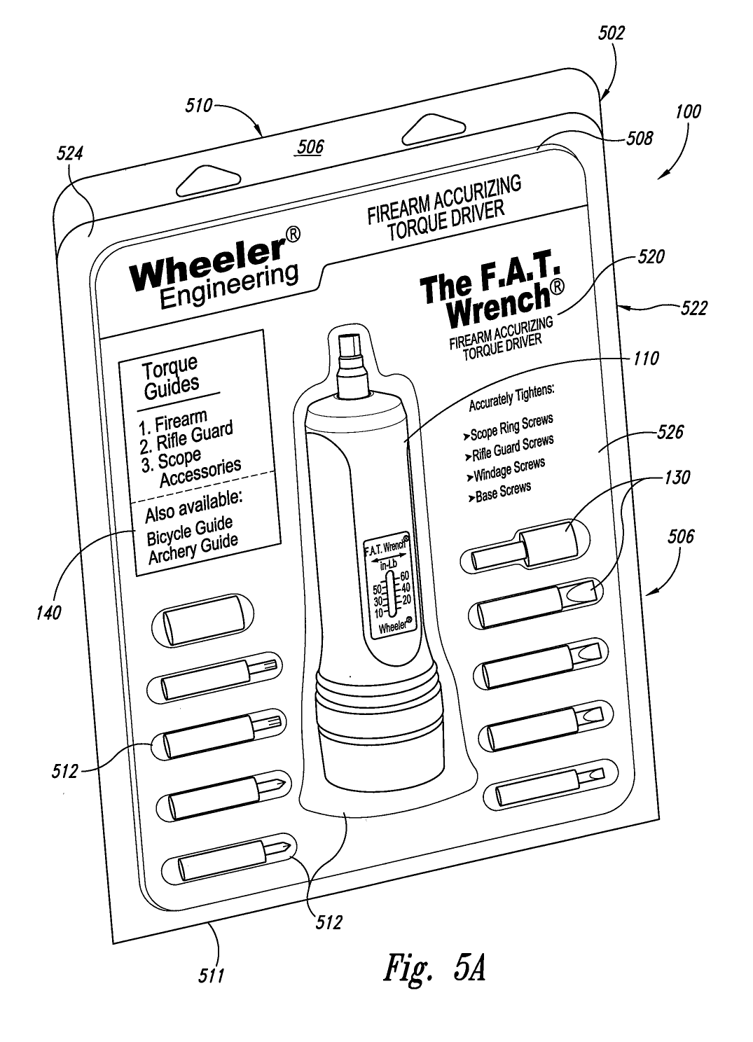

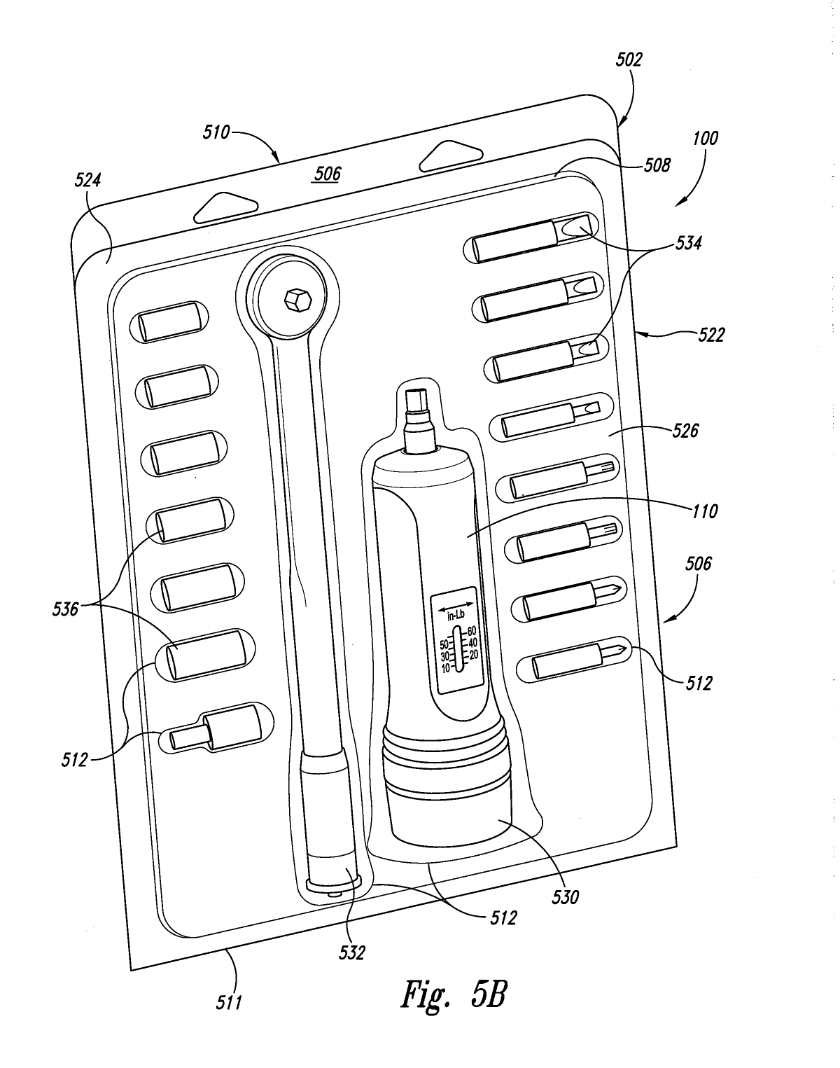

FIG. 5A is a front view of a torque adjusting drive system 100 retained in a package 502 in accordance with an embodiment of the disclosure. In one embodiment, the package 502 may include temporary packaging material 504 for retaining, distributing and displaying the torque adjusting drive system 100. For example, the packaging material 504 may include a transparent plastic cover 506 such that the system 100 is visible through the packaging material 504. However, in other embodiments, the packaging material 504 may include opaque plastic, paper, cardboard, metal, wood, or other supporting material.

The cover 506 may include a front portion 508 and a back portion 510. The front and back portions 508, 510 may have an attachment mechanism for holding the portions in a closed confirmation. In one embodiment, the front portion 508 may be pivotally attached to the back portion 510 such that the front portion 508 can transition between open and closed confirmations. For example, in some embodiments, the cover 506 may be formed from a plastic molding process (e.g., blow molding, injection molding, etc.) as a single unit. In this embodiment, the front portion 508 and back portion 510 can be integrally connected through a living hinge 511 that allows the front portion 508 to pivot relative to the back portion 510.

In another embodiment, not shown, the front and back portions 508, 510 can be formed separately. In this embodiment, the front portion 508 can be coupled to the back portion 510 along one edge region with a moveable hinge (not shown) configured to allow the front portion 508 to rotate about the hinge with respect to the back portion 510. In a further embodiment, the front portion 508 can be separate from the back portion 510 when the cover 506 is in the open configuration. Furthermore, in embodiments in which the front and back portions 508, 510 are manufactured separately, the packaging materials 504 used to form these portions 508, 510 can be the same or different.

In another embodiment, the front portion 508 may be heat-sealed during a manufacturing process. In this embodiment, the package 502 may be a temporary retaining package that must be cut or otherwise destroyed to retrieve the system 100 from the package 510. In another embodiment, the package 510 may be a permanent package or container that can be used to retain, carry and organize the system components. In this embodiment, latching mechanisms such as snaps, reusable adhesive, corresponding hook and loop strips, etc. may be used to releaseably attach the front portion 508 to the back portion 510.

As illustrated in FIGS. 5A and 5B, the cover 506 can provide a secured and enclosed package 502 for retaining and distributing the system 100 when the front portion 508 is positioned to cover the back portion 510. In one embodiment, the front portion 508, the back portion 510, or both front and back portions 508, 510 may be undulated to form recesses 512 for retaining one or more of the driver 110, fastener interfacing attachments 130 and torque guide 140 within the package 502. For example, the recesses may be formed during the molding process. In one arrangement, the recesses 512 may separately retain the system components such that each component (e.g., driver 110, individual fastener interfacing attachments 130, etc.) may be visible through the packaging material 504. When the front portion 508 pivots, or otherwise is removed, to the open the package 502, the interior recesses 514 can be accessed and the driver 110, fastener interfacing attachments 130 and/or torque guide 140 may be retrieved from and/or replaced to the corresponding recesses 512.

Referring to FIG. 5A, the package may also contain a label region 520 configured to contain information 522 related to identification of the system 100 or other information. For example, the label region 520 may include a variety of information 522 useful for selling, instructing and using the system 100. In one embodiment, the label region 520 may have a raised texture formed during the manufacturing process. For example, the information 522 may include a company name and/or logo molded onto the label region 520. In another embodiment, the label region 520 may include a printed label adhesively attached to an outer surface 524 of the package 502. One of ordinary skill in the art will recognize various sizes and shapes of labeling regions 520 as well as various methods of adhering or forming information and designs to an outer surface 524 of the package 502. For example, the labeling region 520 can be formed on the outer surface 524 of the front portion 508 or on the outer surface (not shown) of the back portion 510.

In a further embodiment, the label region 520 may include printed material incorporated into the package 502 and visible through a transparent cover 506. As shown in FIG. 5A, the package 502 includes printed information 522 visible through the front portion 508 of the cover 506. In this embodiment, the printed information 522 or label region 520 does not visibly block the system components (e.g., the driver 110, the fastener interfacing attachments 130, torque guide 140, etc.). In the embodiment shown, the label region 520 includes a label inserted behind the recesses 512 such that the system components are retained intermediate the front portion 508 and the label region 520.

FIG. 5B shows an alternative front view of a torque adjusting drive system 100 retained in a package 502 in accordance with yet another embodiment of the disclosure. This alternative embodiment, and those alternative embodiments and other alternatives described herein, are substantially similar to previously described embodiments, and common acts and structures are identified by the same reference numbers. Only significant differences in operation and structure are described below. FIG. 5B shows a torque adjusting drive system 100 including a first torque driver 530 and a second torque driver 532. In the illustrative embodiment shown, the first torque driver 530 is an in-lb driver and the second torque driver 532 is a ft-lb driver. Alternatively, both torque drivers could be an in-lb driver or both torque drivers could be ft-Id drivers. According to yet another embodiment, a plurality of torque drivers may be included in the torque adjusting drive system 100.

As further shown in FIG. 5B, fastener interfacing attachments 536 are sockets and fastener interfacing attachments 534 are shown as bits. Alternatively, all sockets or all bits may be provided depending on the activity that the system is designed for. For example, in FIG. 5B, seven sockets and eight bits are shown, however, it will be understood by one skilled in the art that each system or kit will be specific to the activity or hobby of intended use.

Thus, in operation and by way of example, tractor-specific torque adjusting drive system kits may include both sockets and bits, and may further be specific to the model of tractor that it is intended to be used with (e.g., a 5500 series John Deere® tractor kit or a 6500 series John Deere® tractor kit). In other applications, for example, in the subcategory of firearms, a universal firearm torque adjusting drive system kit may include fastener interfacing attachments that interface with the majority of firearm attachment devices. Alternatively, a firearm torque adjusting drive system kit may be unique to each make and model of firearm. According to still a further embodiment of the disclosure, the firearm torque adjusting drive system for firearms may include the same torque driver and fastener interfacing attachments in each kit, but may include a torque guide unique to the make and model of the firearm. As will be understood by one skilled in the art, a kit may be created for any number of selected subcategory of activities or products (e.g., bicycles, firearms, archery, small engines, medical devices, tractors, automobiles, boats, and the like).

According to further embodiments, once a subcategory is identified, a torque adjusting drive system kit unique to the subcategory may be provided which may include a optimal torque adjusting driver or drivers and optimal fastener interfacing attachments for the identified subcategory. In addition, separate inserts or guides may be included specific to a product, model and/or make within the subcategory. For example, within the firearm subcategory, types of firearms may be identified (e.g., rifles, handguns, automatic weapons, etc). According to aspects of the disclosure, a plurality of individual torque guides specific to products, models and/or makes within the subcategory may be provided. Alternatively, only one torque guide per system kit may be provided, thus designating each torque adjusting drive system kit for use with a particular product, model and/or make within the subcategory.

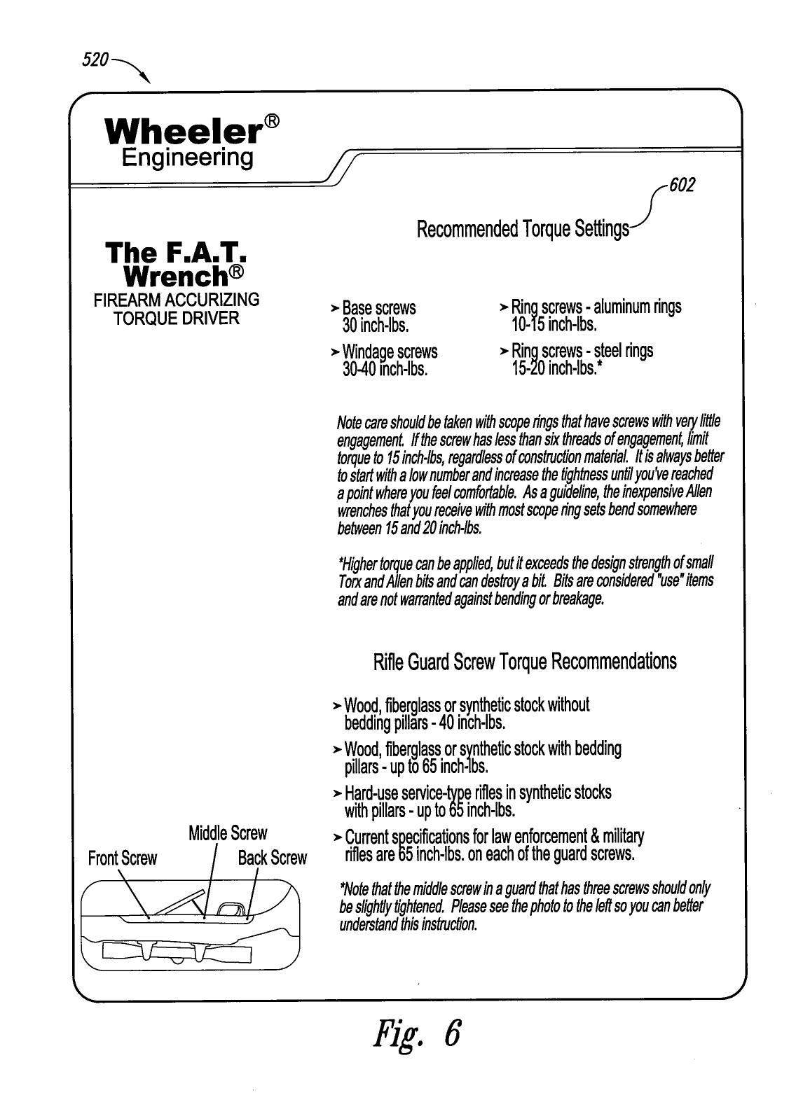

FIG. 6 is a front view illustrating additional information that may be included in the package 502 in accordance with an embodiment of the disclosure. Referring to FIGS. 5 and 6 together, the label region 520 of the package 502 may have information 522 on a front side 526 and a back side 602. In this arrangement, the information 522 on the back side 602 of the label region 520 may be visible through a transparent back portion 510 of the cover 506. The information 522 printed or formed on either the front side 526 or the back side 602 of a label portion 520 may include company information, contact information, reorder information, instructions, information directed the torque guide, explanatory pictures, etc. One of ordinary skill in the art will recognize a number of ways to package the system 100, as well as provide label regions 520 and information 522.

One advantage of the system 100 as described herein is that the torque adjustment drive system 100 may include fastener interfacing attachments 130 adapted for co-action with a torque adjusting driver 110 and configured for specific projects. Additionally the torque guides 140 provide readily available specification information to a user for the specific project that can be referred to during the project. Moreover, the torque guide 140 may include suggested specifications in a task-specific, tool-specific, user-customizable, and efficient manner during use, etc. Furthermore, the torque guides 140 may be replaced, removed, and reused in several aspects of the disclosure. These aspects can improve efficiency during driver use or the duration of a project, as well as reduce frustration when attempting to accurately set a torque value for target fasteners.

Another advantage is that the system 100 may be provided and sold as kits. For example, the system 100 may be provided a single kit directed toward a particular project (e.g., firearm maintenance, rifle guard assembly, bicycle repair, archery equipment assembly, etc.). The kit may include only the specific fastener interfacing attachments 130 and guides 140 required for the specific project. In another embodiment, kit additions may be sold that include a combination of fastener interfacing attachments 130 and guides 140 for specific projects. In this scenario, the driver 110 may be sold and packaged separately. The fastener interfacing attachments 130 provided with particular torque guides 140 may be unique and specific for a particular task corresponding to the guide information. For example, a kit or kit addition directed toward archery equipment related tasks may include a fastener interfacing attachment 130 for that can be used to tighten an arrow broadhead into a threaded portion of an arrow.

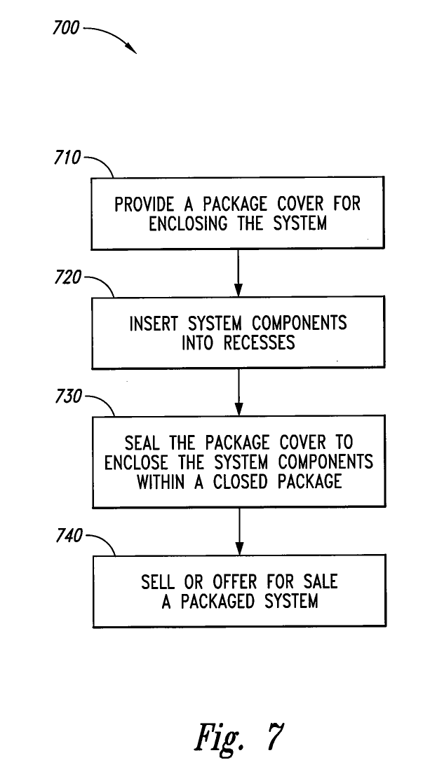

As shown in FIG. 7, the present disclosure provides for a method 700 for packaging a torque adjusting drive system. The method 700 may include providing a package cover for enclosing the system (block 710). The package cover may include recesses for retaining system components. The method 700 may further include inserting system components into the recesses (block 720). For example, a driver, a plurality of fastener interfacing attachments and a torque guide may be inserted into corresponding recesses in the package cover. The method 700 may also include sealing the package cover to enclose the system components within a closed package (block 730). The method 700 may optionally include selling or offering for sale the packaged system (block 740).

From the foregoing, it will be appreciated that specific embodiments of the disclosure have been described herein for purposes of illustration, but that various modifications may be made without deviating from the disclosure. Furthermore, aspects of the disclosure described in the context of particular embodiments may be combined or eliminated in other embodiments. Further, while advantages associated with certain embodiments of the disclosure have been described in the context of those embodiments, other embodiments may also exhibit such advantages, and not all embodiments need necessarily exhibit such advantages to fall within the scope of the disclosure. Accordingly, the disclosure is not limited, except as by the appended claims.

I/we claim:

1. A torque adjusting drive system, comprising:
a torque adjusting driver including
a shaft assembly having a fastener coupling portion;
a torque adjustment mechanism for setting a user-selected torque value; and
a torque value indicator mounted on the driver for displaying at least the user-selected torque value;
a plurality of fastener interfacing attachments configured to couple to the fastener coupling portion and for driving one or more target fasteners; and
a torque guide having a plurality of representative indicia of the target fasteners, wherein the torque guide communicates recommended torque value settings for the target fasteners.

2. The system of claim 1 wherein the torque guide is removable and replaceable.

3. The system of claim 1 wherein the torque guide is releaseably attached to the handle portion and the information on the torque guide includes torque value settings for firearms.

4. The system of claim 1 wherein the torque guide includes torque value settings for bicycles.

5. The system of claim 1 wherein the torque guide includes torque value settings for archery equipment.

6. The system of claim 1 wherein the torque guide includes a label configured to be attached to the shaft assembly.

7. The system of claim 1 wherein the torque guide is engraved on the shaft assembly.

8. The system of claim 1 wherein the torque value indicator includes the torque guide, such that the representative indicia are aligned with the corresponding torque value settings.

9. The system of claim 1 wherein the torque value indicator includes the torque guide, and wherein the representative indicia include color-coded indicia aligned with the corresponding torque value settings and that correspond to the target fasteners.

10. The system of claim 9 wherein the target fasteners are color coded to match with the color-coded indicia.

11. The system of claim 1, further comprising packaging material for packaging and distribution of the torque adjusting drive system, the packaging material configured to retain the torque adjusting driver, the plurality of fastener interfacing attachments and one or more torque guides.

12. The system of claim 1 wherein the torque guide further includes identification information having a name of a manufacture.

13. The container of claim 1 wherein the torque guide is attached to the shaft assembly with an adhesive.

14. The system of claim 11 wherein the torque guide is attached to the packaging.

15. The system of claim 11 wherein the packaging material includes a front portion pivotally attached to a back portion, the front portion configured to cover the back portion in a closed position to form an interior cavity, wherein the interior cavity includes an undulating inner surface for retaining the torque adjusting driver and fastener interfacing attachments in a plurality of recesses.

16. The system of claim 11 wherein at least a portion of the packaging material is transparent such that at least one of the torque adjusting driver and the fastener interfacing attachments are visible through the packaging.

17. The system of claim 11, further including a label region having system related information, wherein the label region is inserted into the package material and has the information printed on front and back sides, and wherein the packaging material includes a transparent region for showing at least one of the front and back sides of the label region.

18. The system of claim 1 wherein the fastener interfacing attachments are hollow ground.

19. The system of claim 1 wherein the fastener interfacing attachments include a surface coating.

20. A torque adjusting drive system, the system comprising:
a torque adjusting driver having a shaft assembly for rotationally adjusting a torque value setting, the shaft assembly including a handle portion and a fastener coupling portion, wherein the handle portion includes an adjustment mechanism for selecting, locking and indicating the torque value setting;
a plurality of fastener interfacing attachments, wherein each fastener interfacing attachment is configured to engage the fastener coupling portion of the shaft assembly on a first fastener interfacing attachment end and engage one or more target fasteners on a second fastener interfacing attachment end;
a torque guide configured to provide one or more suggested torque values for the one or more target fasteners; and
a package for retaining at least one of the torque adjusting driver, the fastener interfacing attachments and the torque guide.

21. The system of claim 20 wherein the torque guide is releaseably attached to the torque adjusting driver.

22. The system of claim 20 wherein the torque guide includes one or more labels for attaching to the torque adjusting driver for user reference.

23. The system of claim 20 wherein the plurality of fastener interfacing attachments and the torque guide is included in a kit and wherein the kit includes at least one of a) fastener interfacing attachments and torque guide for firearm fasteners, b) fastener interfacing attachments and torque guide for bicycle fasteners, and c) fastener interfacing attachments and torque guide for archery equipment.

24. The assembly of claim 20 wherein the torque guide is printed on the torque adjusting driver.

25. A firearm torque adjusting drive system comprising:
a torque adjusting driver having a shaft assembly for rotationally adjusting a torque setting, the shaft assembly including a handle portion and a fastener coupling portion, wherein the handle portion includes an adjustment mechanism for selecting and locking the torque value setting;
a torque value indicator mounted on the driver for displaying at least a user-selected torque value;
one or more fastener interfacing attachments configured to releaseably engage the fastener coupling portion and for releaseably engaging target fasteners; and
a torque guide for providing torque value suggestions corresponding to a desirable applied torque for the target fasteners, wherein the target fasteners are fasteners used on a firearm, the fasteners having one or more drive designs, and wherein the fastener interfacing attachments include one or more fastener interfacing attachment drive designs that correspond to the one or more fastener drive designs.
